(19) United States
(12) Patent Application Publication
(10) Pub. No.: US 2002/0029145 A1
(43) Pub. Date: Mar. 7, 2002

(54) Synthesis of ultra-linguistic utterances

(76) Inventor: Eduardo Reck Miranda, Paris (FR)

Correspondence Address: William S. Frommer, Esq., FROMMER LAWRENCE & HAUG LLP, 745 Fifth Avenue, New York, NY, 10151, US

(21) Appl. No.: 09/872,142

(22) Filed: Jun. 1, 2001

(30) Foreign Application Priority Data
Jun. 2, 2000 (EP) 00 401 561.6

(51) Int. Cl. G10L 13/00

(52) U.S. Cl. 704/258

(57) ABSTRACT

Ultra-linguistic utterances are synthesised by voice synthesis apparatus of source-filter type in which the source module has been replaced by a source module comprising means for generating a succession of sound granule signals, the spectrum of the sound granule signals being controlled according to states of cells of a cellular automaton in respective evolutionary cycles (cⁿ).

The present invention relates to the field of voice synthesis and, more particularly to improving the synthesis of ultra-linguistic utterances.

In the last few years there has been tremendous progress in the development of voice synthesisers, especially in the context of text-to-speech (TTS) synthesisers (see “Progress in Speech Synthesis” ed. J. P. H. van Santen et al, Springer-Verlag, New York, 1996). However, few of these systems consider the capability of producing speech other than standard linguistic utterances.

Apart from the work of a few musicians (see X. Rodet et al “The CHANT project: from synthesis of the singing voice to synthesis in general”, Computer Music Journal, Vol.8, No.3, pp15-31; J. M. Clarke et al “VOCEL: New implementation of the FOF synthesis method”, Proceedings of the international Computer Music Conference ICMC98, pp.357-365; and T. Wishart, “On Sonic Art” Contemporary Music Studies, Vol.12, ed. S. Emmerson, pub1. Gordon and Breach, Reading (UK), 1996) interested in exploring the capabilities of synthesised voice for producing unusual singing effects, there has not been much systematic research into speech synthesisers that support the production of utterances that are beyond the ordinarily spoken syllables and words. This class of utterances is referred to as ultra-linguistic and includes onomatopoiea, giggling, unusual vocal inflexions, etc.

There are two main fundamental approaches to voice synthesis, the sampling approach (sometimes referred to as the concatenative or diphone-based approach) and the source-filter (or “articulatory” approach). In this respect see “Computer Sound Synthesis for the Electronic Musician” by E. R. Miranda, Focal Press, Oxford, UK, 1998.

The sampling approach makes use of an indexed database of digitally recorded short spoken segments, such as syllables, for example. In certain systems, some form of analysis is performed on the recorded sounds in order to enable them to be represented more effectively in the database. When it is desired to produce an utterance, a playback engine then assembles the required words by sequentially combining the appropriate recorded short segments.

The sampling approach to voice synthesis is the approach that is generally preferred for building TTS systems and, indeed, it is the core technology used by most computer-speech systems currently on the market. A significant limitation of this approach is the fact that the sound repertoire is highly dependent upon the content of the sampled database. It is not practical to attempt to store all variations of ultra-linguistic utterances in a database because these utterances are highly dynamic; they are much more susceptible to variation than standard syllables. Therefore, it is necessary to find a model that allows for good insight into the functioning of the human vocal system, in order to simulate the dynamics thereof. The source-filter approach offers this capability.

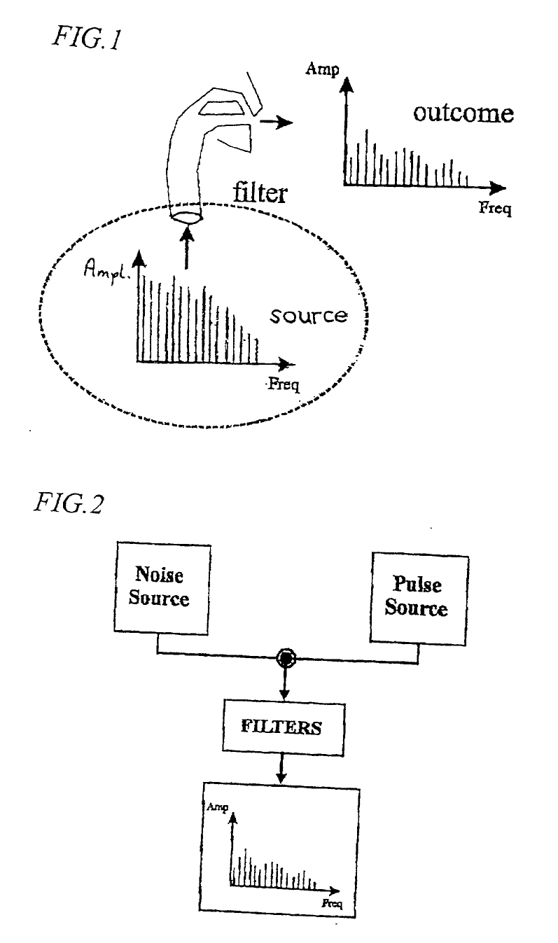

The source-filter approach produces sounds from scratch by mimicking the functioning of the human vocal tract—see FIG. 1. The source-filter model is based upon the insight that the production of vocal sounds can be simulated by generating a raw source signal that is subsequently moulded by a complex filter arrangement (or resonator). In this context see, for example, “Software for a Cascade/Parallel Formant Synthesiser” by D. Klatt from the Journal of the Acoustical Society of America, 63(2), pp.971-995, 1980.

In humans, the raw sound source corresponds to the outcome from the vibrations created by the glottis (opening between the vocal chords) and the complex filter corresponds to the vocal tract. The complex filter can be implemented in various ways. In general terms, the vocal tract is considered as a tube (with a side-branch for the nose) sub-divided into a number of cross-sections whose individual resonances are simulated by digital filters.

In order to facilitate the specification of the parameters for these filters, the system is normally furnished with an interface that converts articulatory information (e.g. the positions of the tongue, jaw and lips during utterance of particular sounds) into filter parameters; hence the reason the source-filter model is sometimes referred to as the articulatory model (see “Articulatory Model for the Study of Speech Production” by P. Mermelstein from the Journal of the Acoustical Society of America, 53(4), pp.1070-1082,1973). Utterances are then produced by telling the program how to move from one set of articulatory positions to the next, similar to a key-frame visual animation where the animator creates key frames and the intermediate pictures are automatically generated by interpolation. In other words, a control unit controls the generation of a synthesised utterance by setting the parameters of the sound source(s) and the filters for each of a succession of time periods, in a manner which indicates how the system moves from one set of “articulatory positions”, and source sounds, to the next in successive time periods. The filtering module interpolates between the articulatory positions specified by the control means.

In conventional voice synthesisers, it is not the filter arrangements for simulating the response of the vocal tract that are inadequate for use in synthesis of ultra-linguistic utterances. On the contrary, it is the conventional means for producing the raw sound signal (source signal), simulating the vibrations of the glottis, that do not function well when ultra-linguistic utterances are concerned.

The preferred embodiments of the present invention provide voice synthesis apparatus and methods based on a source-filter approach, in which a new type of source component enables improved synthesis of ultra-linguistic utterances.

The speech stream can be viewed as evolving convoluted spectral forms. The greater part of the source signals produced by the human vocal tract result from the modulation of turbulent noise, forced upwards through the trachea from the lungs, by the (quasiperiodic) vibration of the vocal folds at the base of the larynx; below the term source-stream will be used to refer to this signal. Conventionally, the source-stream is simulated using two types of generators: one generator of white noise (to simulate the production of turbulent noise, which is most evident in consonants, aspiration and fricative effects, etc.) and one (or more) generators of periodic pulses (to simulate the production of the periodic vibrations normally associated with vowels). This conventional structure is illustrated in FIG. 2. By carefully controlling the amount of signal that each generator sends to the filters, one can roughly simulate whether the vocal folds are tensioned (periodic signal) or not (turbulence), with various degrees in between these two states.

A number of variations of this basic model have been proposed in order to furnish the source-stream with more realism (e.g., “Text-to-Speech Synthesis with Dynamic Control of Source Parameters”, by L. C. Oliveira, and “Modification of the Apreriodic Component of Speech Signals for Synthesis” by G. Richard and C. R. d'Alessandro, both from “Progress in Speech Synthesis” eds. J. P. H. van Santen et al, New York (USA), Springer-Verlag, 1997; to cite but two), but none of these has addressed the needs of ultralinguistic utterances.

The problem is that ultra-linguistic utterances require highly dynamic spectra and the conventional paradigm fails to provide good support for this type of spectral behaviour. In practical terms, the filters alone are not capable of imposing the required spectral evolution on a source-stream whose spectrum remains constant during emission. Rather, it is necessary to produce the source-stream in a highly non-linear, chaotic fashion. This would then give the filters a signal containing the right spectral ingredients for their task.

In the preferred embodiments of the present invention, the source component of a synthesiser based on the source-filter approach is improved by replacing the conventional source module with an alternative source-stream generator that is capable of producing the spectral behaviour required for ultra-linguistic utterances. This source generator is based on granular synthesis, a sound synthesis technique that heretofore has been exercised only in the context of generation of electronic music (see “Computer Sound Synthesis for the Electronic Musician”, by E. R. Miranda, Focal Press, Oxford, England, 1998).

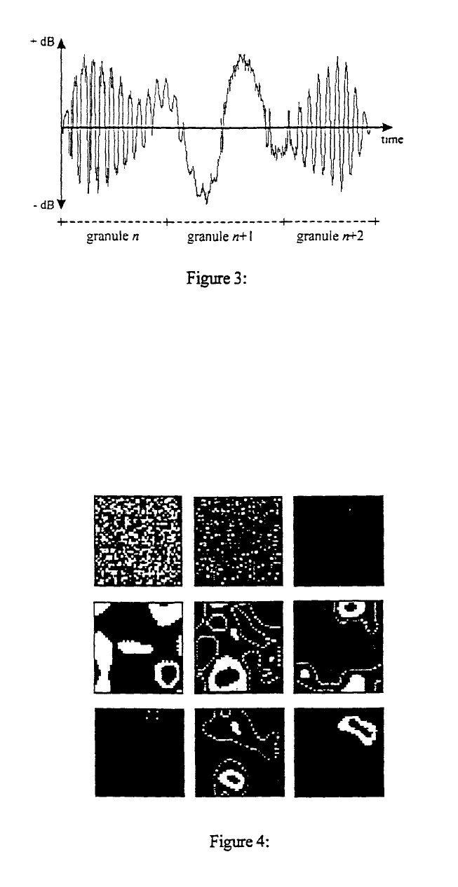

The functioning of the source-stream generator according to the present invention can be compared with a motion picture in which an impression of continuous movement is produced by displaying a sequence of visual frames at a rate beyond the scanning capability of the human eye. In this case, the visual frames are replaced by ‘sonic frames’, which are referred to as sound granules here. A wide range of different sounds can be produced by streaming sequences of sound granules. FIG. 3 illustrates a sequence of three sound granules. A rapid succession of thousands of such granules would be necessary in order to form large complex sounds.

These sound granules should normally be very short (e.g., 30 milliseconds long) but their duration may, of course, change during the streaming process (this will become clearer below). Complex and dynamic sounds can be generated, according to the degree of similarity of the granules; the higher the similarity, the more homogeneous is the outcome spectrum, and vice versa.

The concept of streaming sound granules in order to produce the source-streams is very powerful in the sense that it allows for fine control at the level of the single particles of the stream. The main difficulty of the technique is that the specification of the nature of each of these particles (e.g., the waveform, the amplitude, the frequency and the duration) requires the management of a very large number of parameters; for example, if each granule requires 4 parameters, then a 2 seconds stream using granules of 40 milliseconds each, would require the specification of 400 different variables. Moreover, it is very difficult to predict the role of these variables in the overall result. One clearly needs a high-level controller for these granules and this is not a trivial problem.

The present inventor initially conducted experiments using stochastic formulae (i.e., probabilities) to control the evolution of the granules. However, this method did not prove to be satisfactory because the outcome lacked the organic behaviour desired for the source signal; for example, the dynamics of realistic spectral evolution, such as the turbulent attack, the periodic sustain and the fading release stages, could seldom be heard.

The present invention makes use of the self-organisation behaviour of cellular automata for controlling the spectral unfolding of the source-stream in the synthesis of ultra-linguistic utterances by a source-filter approach. Experiments have shown that use of such cellular automata gives improved performance compared with use of stochastic formulae or use of conventional source modules for generating the source stream.

Cellular automata (CA) are computer modelling techniques originally introduced in the 1960s by von Neumann and Ulan (see “Cellular Automata” by E. F. Cood, Academic Press, London, England, 1968). Since then CA have been repeatedly reintroduced and applied for a considerable variety of modelling purposes; see, for example, “Cellular Automata and Complexity” by Wolfram, Addison-Wesley, Reading, 1994.

In general, CA are implemented on a computer as a regular array or matrix of cells; they can normally have one, two or three dimensions. Each cell may assume values from a finite set of integers and each value is normally associated with a colour. The functioning of cellular automata is displayed on the computer screen as a sequence of changing patterns of tiny coloured cells, according to the tick of an imaginary clock, like an animated film. At each tick of the clock, the values of all cells change simultaneously, according to a set of transition rules that takes into account the values of their neighbourhood, normally four or eight neighbours.

To control the source-stream generator of the synthesiser, the preferred embodiments of the present invention employ an automaton that is an adapted version of an algorithm that has been used to model the behaviour of a number of oscillatory and reverbatory phenomena, such as Belouzow-Zhabotinsky-style chemical reactions, as described by Dewdney in “A cellular universe of debris, droplets, defects and demons”, from Scientific American, Aug. 1989, pp 88-91. This automaton has already been successfully used in the granular synthesis of music by computer, in a system called Chaosynth™ (see “Granular Synthesis of Sounds by Means of Cellular Automata” by E. R. Miranda, from Leonardo, Vol. 28, Nr. 4, pp. 297-300, 1995).

The automaton used by the preferred embodiments consists of a matrix of cells of identical nature. The cells could be implemented using identical computers, identical equations or variables of identical type (i.e. integers, or decimals, etc.). In the preferred embodiments, the cells use variables of identical type (taking integer values). The variable value for each cell is updated at each cycle t of an imaginary clock according to the states of its eight nearest neighbours. At a given moment cells can be in any one of the following states: a) quiescent, b) in a state of depolarisation or c) collapsed. There are three parameters required for cell update, namely: r₁, r₂ and k. The first two represent the cell's resistance to becoming depolarised, the third is the capacitance (as electrical capacitance) of the cell and controls the rate of depolarisation. Considering that the state of a cell of the cellular automaton at a time t is denoted m¹, that A and B represent, respectively, the number of collapsed and depolarised cells amongst the eight nearest neighbours of this cell, and that S represents the sum of the nearest neighbours' states, then the cells are updated by the following functions, according to their respective conditions:

| | |
|---|---|
| m^{t + 1} = int(A/r₁) + int(B/r₂) | if m^{t} = 0 |
| m^{t + 1} = int((S/A) + k) | if 0 < m^{t} < x − 1 |
| m^{t + 1} = 0 | if m^{t} = x − 1 |

In practice, the states of the cells are represented by an integer between 0 and x−1 inclusive (x=the number of different states). One of the attractive features of this particular automaton is that it allows for a variable number of different states, in this case x. A cell in state 0 corresponds to a quiescent state, whilst a cell in state x−1 corresponds to a collapsed state. All states in between exhibit a degree of depolarisation, according to their respective values. The closer the cell's state value gets to x-1, then the more depolarised it becomes.

This cellular automaton is interesting because of its dynamic self-organising behaviour: it tends to evolve from an initial wide distribution of cell's states in the grid towards oscillatory cycles of patterns. FIG. 4 illustrates this self-organising behaviour of the cellular automaton in question. FIG. 4 shows various snapshots taken from a visual representation of the cellular automaton as the states thereof change over time (starting from the top left, progressing to top right, then middle row left-to-right, and ending bottom right). This visual representation was obtained by assigning different colours to each of the possible cell states.

The behaviour of this cellular automaton matches the type of dynamics that are required in the source-stream when ultra-linguistic utterances are to be synthesised: it is desired that the signals should tend to evolve from a wide distribution of their spectrum at the onset, up to quasi-periodical oscillations. Also, and more importantly, the rate of this evolution is controllable via the values of the parameters r₁, r₂ and k.

Further features and advantages of the present invention will become clear from the following description of preferred embodiments thereof, given by way of example, illustrated by the accompanying drawings, in which:

FIG. 1 illustrates the principle behind source-filter type voice synthesis;

FIG. 2 is a block diagram illustrating the general structure of a conventional voice synthesiser following the source-filter approach;

FIG. 3 is a graph illustrating a sequence of three sound granules;

FIG. 4 is a diagram illustrating the evolution over time of a cellular automaton of the type used in preferred embodiments of the present invention;

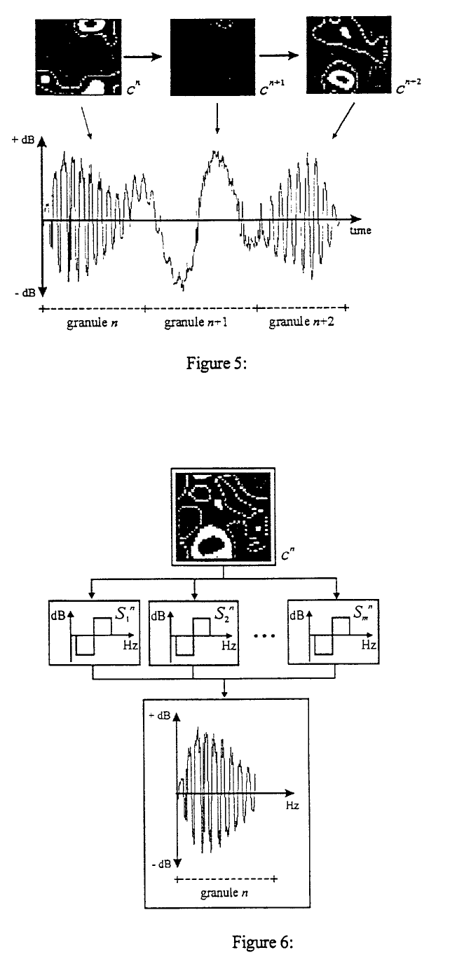

FIG. 5 schematically illustrates how sound granules are derived from the evolutionary states of a cellular automaton in preferred embodiments of the invention;

FIG. 6 is a block diagram illustrating schematically how, in the preferred embodiments, the spectrum of a sound granule is derived from signals produced by signal generators associated with a cellular automaton;

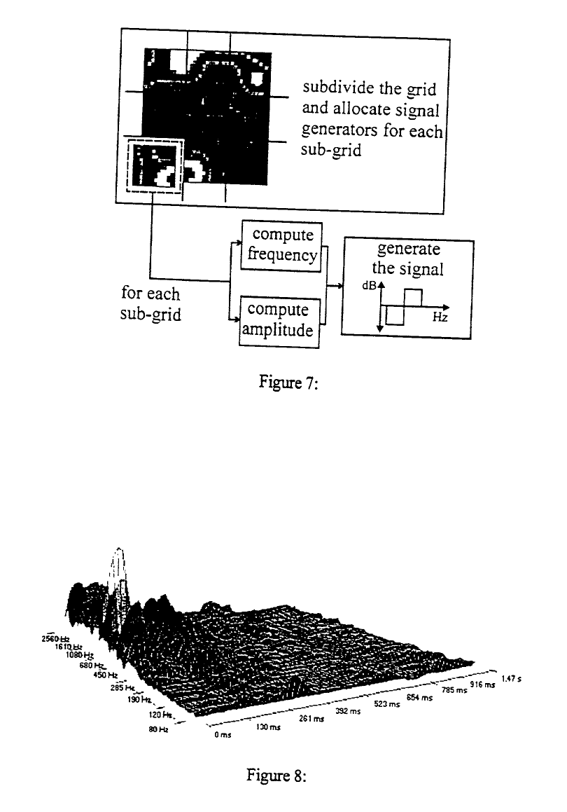

FIG. 7 schematically illustrates the process according to preferred embodiments of the invention whereby component signals to make up a sound granule are generated from signal generators associated with sub-grids of a cellular automaton;

FIG. 8 illustrates an ultra-linguistic utterance generated by a synthesiser using a source module according to the preferred embodiment of the invention;

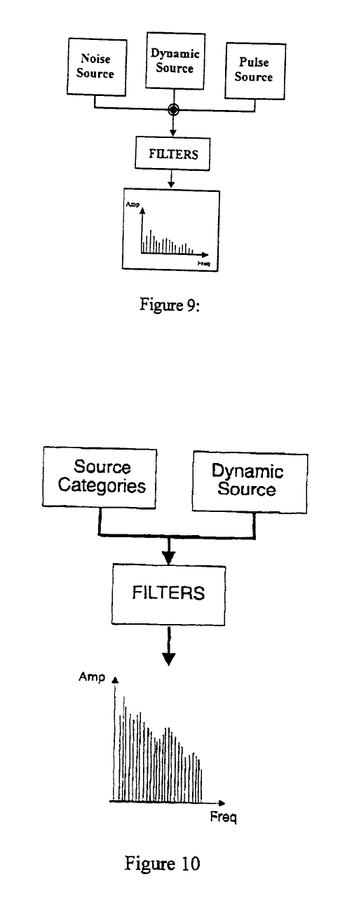

FIG. 9 shows the general structure of a source module according to an embodiment of the invention for a synthesiser generating standard linguistic sounds, and

FIG. 10 show the general structure of a source module according to an embodiment of the invention combining the source-stream generator of the preferred embodiments and a library-based source signal generator.

As mentioned above, in the voice synthesis method and apparatus according to preferred embodiments of the invention, the conventional sound source of a source-filter type synthesiser is replaced by a source module using a particular type of cellular automaton.

Any convenient filter arrangement modelling the vocal tract can be used to process the output from the source module according to the present invention. Optionally, the filter arrangement can model not just the response of the vocal tract but can also take into account the way in which sound radiates away from the head. The corresponding conventional techniques can be used to control the parameters of the filters in the filter arrangement. See, for example, Klatt quoted supra.

However, preferred embodiments of the invention use the waveguide ladder technique (see, for example, “Waveguide Filter Tutorial” by J. O. Smith, from the Proceedings of the international Computer Music Conference, pp.9-16, Urbana (IL):ICMA,1987) due to its ability to incorporate non-linear vocal tract losses in the model (e.g. the viscosity and elasticity of the tract walls). This is a well known technique that has been successfully employed for simulating the body of various wind musical instruments, including the vocal tract (see “Towards the Perfect Audio Morph? Singing Voice Synthesis and Processing” by P. R. Cook, from DAFX98 Proceedings, pp. 223-230, 1998).

Descriptions of suitable filter arrangements and the control thereof are readily available in the literature in this field and so no further details thereof are given here.

The apparatus and methods according to the preferred embodiment of the present invention for synthesising ultra-linguistic utterances will now be described in detail with reference to FIGS. 5 to 8.

As mentioned above, in the synthesis of ultra-linguistic utterances by methods and apparatus according to the preferred embodiment of the invention, a succession of sound granules corresponding to a given ultra-linguistic sound is generated under the control of a cellular automaton of particular type. The automaton drives the source-stream generator as follows: at each of a series of time intervals t, the automaton produces one sound-granule n, of duration dₙ, corresponding to one cycle cⁿ in the automaton's evolution. The source-stream for synthesis of the desired sound is made up of a succession of N sound granules.

FIG. 5 illustrates how three successive cycles, cⁿ, cⁿ⁺¹, cⁿ⁺² of the automaton's evolution correspond to a succession of three sound granules (although it is to be understood that the particular automaton states represented in FIG. 5 do not necessarily give rise to the particular spectra illustrated in FIG. 5 for the sound granules).

The preferred embodiments of the invention make use of a cellular automaton composed of a p×q matrix of cells. At a given moment, cells can be in any one of the following states: a) quiescent, b) in a state of depolarisation or c) collapsed. Initially, all cells of the matrix are in the same state m and take the same value. At each cycle in the automaton's evolution the states of the cells are updated according to the following algorithm:

| | |
|---|---|
| m^{t + 1} = int(A/r₁) + int(B/r₂) | if m^{t} = 0 |
| m^{t + 1} = int((S/A) + k) | if 0 < m^{t} < x − 1 |
| m^{t + 1} = 0 | if m^{t} = x − 1 |

where m^{t} represents the cell's state at time t, A and B represent the number of collapsed and depolarised cells, respectively, amongst the eight nearest neighbours of this cell, S represents the sum of the nearest neighbours' state values, r₁, and r₂ represent the cell's resistance to becoming depolarised and k is the cell capacitance and controls the rate of depolarisation.

The states of the cells are represented by a number between 0 and x−1 (x=the total number of different states). A cell in state 0 corresponds to a quiescent state, whilst a cell in state x−1 corresponds to a collapsed state. All states in between exhibit a degree of depolarisation, according to their respective values (a cell state value close to x-1, represents a cell that has a high degree of depolarisation).

In order to visualise the behaviour of a cellular automaton on the computer, each possible cell state mₓ, is normally associated with a colour, but in our case we associate these states to various frequency and amplitude values. Possible values for the frequencies and amplitudes associated with the different cellular automaton cell states are given in Table 1 below.

TABLE 1

| CA State | Value | Colour | Frequency | Amplitude |
|---|---|---|---|---|
| m₀ | 0 | white | 110 Hz | 0dB |
| m₁ | 1 | red | 220 Hz | −3dB |
| m₂ | 2 | blue | 330 Hz | −6dB |
| ... | ... | ... | ... | ... |
| mₓ | x − 1 | Zₓ | Fₓ | Ampₓ |

In order to derive sound granule waveforms from the different states of the cellular automaton cells, signal generators are associated with sub-grids of the matrix.

In particular, the matrix of the automaton is sub-divided into a number I of smaller uniform sub-grids of cells and a signal generator i is associated to each of the I sub-grids. The signal generators can produce three basic types of waveforms: sinusoid, pulse or pink noise. At each cycle cⁿ in the evolution of the cellular automaton, the I signal generators associated with the sub-grids simultaneously produce respective signals Sᵢⁿ. These signals are added in order to compose the spectrum of the respective granule (FIG. 6). In other words:

$${ω}^{n} = {\sum }_{i = 1}^{I} {S}_{i}^{n}$$

where ωⁿ is the sound granule waveform corresponding to cycle cⁿ, Sᵢⁿ is the spectrum produced by signal generator i during cycle cⁿ, and I is the total number of signal generators associated with the CA matrix.

The frequency Fᵢⁿ and the amplitude Ampᵢⁿ values for each signal generator i during cycle cⁿ are determined by the arithmetic mean over the frequency and the amplitude values associated to the states of the cells of their corresponding sub-grid during this cycle:

$${F}_{i}^{n} = \{ {\sum }_{h = 1}^{H} {φ}_{h}^{n} \} / H {Amp}_{i}^{n} = \{ {\sum }_{h = 1}^{H} {τ}_{h}^{n} \} / H$$

where φₕⁿ and τₕⁿ are the frequency and amplitude of cell h during cycle cⁿ and H is the total number of cells of the sub-grid.

The duration T of a whole sound-stream is given by the total number N of cycles c¹, c², . . . , cⁿ and the duration dₙ of the individual granules; for example, 100 configurations of granules of 40 milliseconds each would result in a sound event of 4 seconds duration. More particularly:

$$T = {\sum }_{n = 1}^{N} {d}_{n}$$

A variety of distinct sound-streams can be obtained by varying a number of settings, as follows:

the dimensions p×q of the cellular automaton matrix (i.e., the total number of cells)

the number I of signal generators according to the subdivision of the matrix into sub-grids

the type of signal generator that is allocated to each sub-grid (i.e., sinusoid, pulse, pink noise or a combination of these)

the duration of the individual granules (dₙ)

the number (x) of states (mₓ) that can be assigned to the cells of the automaton and the frequencies and amplitudes associated to these states (φₕ and τₕ)

the values for the resistors (r₁ and r₂) and for the capacitor (k) of the cellular automaton

the number of cycles N (i.e., total number of granules in the sound-stream)

Most of these settings can be interpolated during emission in order to increase the dynamics of the outcome.

As with all articulatory synthesisers, it is not a trivial task to predict behaviour. In other words, it is hard to determine the specific settings to produce an imagined utterance. Notwithstanding, further research will show the role of each parameter in order to be able to accurately predict the outcome.

The self-organising dynamic system described above is interesting because it explores the behaviour of the cellular automaton in order to produce source-streams in a way which resembles the evolution of natural sounds during their emission; their partials converge from a wide distribution (as in the noise attack of a consonant) to oscillatory patterns (the characteristic of a sustained tone such as a vowel). The random initialisation of states in the grid produces an initial wide distribution of frequency and amplitude values, which tend to settle to a periodic fluctuation.

In experiments, vocal-like sounds have been synthesised using up to 64 different states (that is up to 64 different frequency and amplitude values) and up to 64 generators, on grids of up to 4,000,000 cells (2,000×2,000). The outcome has tended to exhibit a great sense of organic movement and flow. Indeed the system produced many realistic onomatopoeia and other ultra-linguistic sounds. As an example, FIG. 8 portrays the frequency-domain FFT representation of an ultra-linguistic utterance produced by a synthesiser of source-filter type in which the source module was implemented according to the preferred embodiment described above.

FIG. 8 shows the richness of the spectrum topology and its organic unfolding, indicating that the articulator (that is, the filters) did a good job thanks to the nature of the signal received from the source generator.

The source-stream generator according to the present invention also has good potential to enrich currently available source-filter synthesis technology used for synthesising usual linguistic sounds, by using it in association with standard source generators. This configuration is illustrated in FIG. 9. The new source stream generator could also be used in association with the present inventor's library-based source signal generator that is the subject of a European patent application entitled “Improving The Expressivity Of Voice Synthesis” filed simultaneously with the present application. The latter configuration, and a possible output signal therefrom, is illustrated in FIG. 10.

Although the present invention has been described above in relation to specific embodiments thereof, it is to be understood that numerous detailed modifications may be made without departing from the present invention as defined in the accompanying claims.

Also, it is to be understood that references herein to the vocal tract do not limit the invention to systems that mimic human voices. The invention covers systems which produce a synthesised voice (e.g. voice for a robot) which the human vocal tract typically will not produce.

1. Voice synthesis apparatus comprising:
a source module adapted to generate a raw sound signal simulating the outcome from vibrations created by the glottis, and
a filter module arranged to receive the raw sound signal produced by the source module and apply thereto a transfer function which simulates the response of the vocal tract;
characterised in that the source module comprises means for generating a succession of sound granule signals to constitute said raw sound signal and means for controlling the spectrum of the sound granule signals according to states of cells of a cellular automaton.

2. Voice synthesis apparatus according to claim 1, wherein the apparatus is adapted to generate ultra-linguistic utterances.

3. Voice synthesis apparatus according to claim 1, wherein the sound granule signal spectrum controlling means is adapted to generate a sound granule signal by summing the signals produced by a plurality of signal generators, the signal produced by each of the signal generators being dependent upon the state of one or more cells of the cellular automaton.

4. Voice synthesis apparatus according to claim 3, and comprising means for designating, for each signal generator, one of a plurality of different waveforms to be output.

5. Voice synthesis apparatus according to claim 3, wherein the sound granule signal spectrum controlling means comprises means for setting the number of signal generators used for production of the sound granule signal spectrum to one of a plurality of different possible values.

6. Voice synthesis apparatus according to claim 3, wherein the states of the cells of the cellular automaton are each associated with respective frequency and amplitude values.

7. Voice synthesis apparatus according to claim 6, wherein the sound granule signal spectrum controlling means comprises a plurality of signal generators, each sound signal generator being associated with a sub-grid of cells of the cellular automaton, the frequency and amplitude of the sound signal generated by each sound generator being dependent upon the state of the cells of the sub-grid with which the sound generator is associated.

8. Voice synthesis apparatus according to claim 7, wherein the frequency (Fₗⁿ) and the amplitude (Ampₗⁿ) values for each signal generator (i) during a cycle (cⁿ) of the cellular automaton are determined by the arithmetic mean over the frequency and the amplitude values associated with the states of the cells with which the signal generator is associated:
$${F}_{i}^{n} = \{ {\sum }_{h = 1}^{H} {φ}_{h}^{n} \} / H {Amp}_{i}^{n} = \{ {\sum }_{h = 1}^{H} {τ}_{h}^{n} \} / H$$
where φₕⁿ and τₕⁿ are the frequency and amplitude of cell h during cycle cⁿ and H is the total number of cells with which the signal generator is associated.

9. Voice synthesis apparatus according to claim 1, wherein the cells of the cellular automaton can take states corresponding to integer values from 0 to x−1 and, at each cycle in the evolution of the cellular automaton, the state of each cell is updated dependent upon the states of the nearest neighbours of said cell according to the following algorithm:

| | |
|---|---|
| m^{t + 1} = int(A/r₁) + int(B/r₂) | if m^{t = 0} |
| m^{t + 1} = int((S/A) + k) | if 0 < m^{t} < x − 1 |
| m^{t + 1} = 0 | if m^{t} = x − 1 |

where m^{t+1} is the cell state at a time period t+1 (after updating), m^{t} is the cell state at time t (before updating), A and B represent, respectively, the number of cells taking state value x−1 and state values in the range 1 to x−2 amongst the eight nearest neighbours of this cell, S represents the sum of the nearest neighbours' states, r₁ and r₂ represent the cell's resistance to an increase in state value and k controls the rate of increase of state value.

10. Voice synthesis apparatus according to claim 9, wherein the sound granule signal spectrum controlling means comprises means for setting each of the parameters r₁, r₂ and k to a respective one of a plurality of different possible values.

11. Voice synthesis apparatus according to claim 1, wherein the sound granule signal spectrum controlling means comprises means for setting the dimensions of the cellular automaton to one of a plurality of different possible values.

12. Voice synthesis apparatus according to claim 1, wherein the sound granule signal spectrum controlling means comprises means for setting the number of states that can be assigned to the cells of the cellular automaton to one of a plurality of different possible values.

13. Voice synthesis apparatus according to claim 1, wherein the sound granule signal spectrum controlling means comprises means for setting the duration of the individual sound granules to one of a plurality of different possible values.

14. Voice synthesis apparatus according to claim 1, wherein the sound granule signal spectrum controlling means comprises means for setting the total number of sound granules making up the raw sound signal to one of a plurality of different possible values.

15. A method of voice synthesis comprising the steps of:
providing a source module adapted to generate a raw sound signal simulating the outcome from vibrations created by the glottis, and
providing a filter module arranged to receive the raw sound signal produced by the source module and apply thereto a transfer function which simulates the response of the vocal tract;
characterised in that the source module providing step comprises providing a source module including means for generating a succession of sound granule signals to constitute said raw sound signal, wherein the spectrum of the sound granule signals is controlled according to states of cells of a cellular automaton.

16. A method of synthesising ultra-linguistic utterances according to claim 15, wherein a sound granule signal is generated by summing the signals produced by a plurality of signal generators, the signal produced by each of the signal generators being dependent upon the state of one or more cells of the cellular automaton.

17. A method of synthesising ultra-linguistic utterances according to claim 16, wherein the waveform output by each signal generator is selected from one of a plurality of different waveforms.

18. A method of synthesising ultra-linguistic utterances according to claim 16, wherein the number of signal generators used for production of the sound granule signal spectrum is set to one of a plurality of different possible values.

19. A method of synthesising ultra-linguistic utterances according to claim 16, wherein the states of the cells of the cellular automaton are each associated with respective frequency and amplitude values.

20. A method of synthesising ultra-linguistic utterances according to claim 19, wherein the sound granule signal spectrum controlling means comprises a plurality of signal generators, each sound signal generator being associated with a sub-grid of cells of the cellular automaton, the frequency and amplitude of the sound signal generated by each sound generator being dependent upon the state of the cells of the sub-grid with which the sound generator is associated.

21. A method of synthesising ultra-linguistic utterances according to claim 20, wherein the frequency (Fₗⁿ) and the amplitude (Ampᵢⁿ) values for each signal generator (i) during a cycle (cⁿ) of the cellular automaton are determined by the arithmetic mean over the frequency and the amplitude values associated with the states of the cells with which the signal generator is associated:
$${F}_{i}^{n} = \{ {\sum }_{h = 1}^{H} {φ}_{h}^{n} \} / H {Amp}_{i}^{n} = \{ {\sum }_{h = 1}^{H} {τ}_{h}^{n} \} / H$$
where φₕⁿ and τₕⁿ are the frequency and amplitude of cell h during cycle cⁿ and H is the total number of cells with which the signal generator is associated.

22. A method of synthesising ultra-linguistic utterances according to claim 15, wherein the cells of the cellular automaton can take states corresponding to integer values from 0 to x−1 and, at each cycle in the evolution of the cellular automaton, the state of each cell is updated dependent upon the states of the nearest neighbours of said cell according to the following algorithm:

| | |
|---|---|
| m^{t + 1} = int(A/r₁) + int(B/r₂) | if m^{t} = 0 |
| m^{t + 1} = int((S/A) + k) | if 0 < m^{t} < x − 1 |
| m^{t + 1} = 0 | if m^{t} = x − 1 |

where m^{t+1} is the cell state at a time period t+1 (after updating), m^{t} is the cell state at time t (before updating), A and B represent, respectively, the number of cells taking state value x−1 and state values in the range 1 to x−2 amongst the eight nearest neighbours of this cell, S represents the sum of the nearest neighbours' states, r₁ and r₂ represent the cell's resistance to an increase in state value and k controls the rate of increase of state value.

23. A method of synthesising ultra-linguistic utterances according to claim 22, wherein each of the parameters r₁, r₂ and k is dynamically set to a respective one of a plurality of different possible values.

24. A method of synthesising ultra-linguistic utterances according to claim 15, wherein the dimensions of the cellular automaton are dynamically set to one of a plurality of different possible values.

25. A method of synthesising ultra-linguistic utterances according to claim 15, wherein the number of states that can be assigned to the cells of the cellular automaton are dynamically set to one of a plurality of different possible values.

26. A method of synthesising ultra-linguistic utterances according to claim 15, wherein the duration of the individual sound granules is dynamically to one of a plurality of different possible values.

27. A method of synthesising ultra-linguistic utterances according claim 15, wherein the total number of sound granules making up the raw sound signal is dynamically set to one of a plurality of different possible values.
